(19) United States
(12) Patent Application Publication
(10) Pub. No.: US 2019/0356044 A1
(43) Pub. Date: Nov. 21, 2019

(54) SYSTEMS INVOLVING SUPER WIDE BAND VERTICAL ANTENNA

(71) Applicant: Venti Group LLC, Miami Beach, FL (US)

(72) Inventors: Dow A. Eichenlaub, Miami Beach, FL (US); Phillip Lindsey, Derby, KS (US); Henry George Adamany, Laguna Hills, CA (US)

(21) Appl. No.: 16/414,722

(22) Filed: May 16, 2019

Related U.S. Application Data
(60) Provisional application No. 62/672,866, filed on May 17, 2018.

(51) Int. Cl. H01Q 1/36; H01Q 1/50; H01Q 1/42

(52) U.S. Cl. CPC H01Q 1/36; H01Q 1/42; H01Q 1/50

(57) ABSTRACT

An example system incorporates: an antenna structure having a feed structure and a top radiating element attached to the feed structure; the feed structure having a downwardly pointed, contiguous V-shaped body portion with an upper side extending between first and second inwardly extending sides, the first and second sides meeting at an apex of the V-shaped body portion; the top radiating element being attached to the feed structure along the upper side.

### BACKGROUND

### Technical Field

The present disclosure generally relates to antennas.

### Description of the Related Art

Antenna design has always been filled with performance compromises. Omni patterns, antenna size, antenna VSWR (Return LOSS), and bandwidth are design factors and performance requirements that are frequently in conflict. Designers and engineers are constantly required to establish priorities in antenna performance and are then required to make compromises in their antenna designs in an attempt to meet the increasing demands of today's cellular and other communication networks.

In this regard, there are several different ways to categorize an antenna. One category is Omni or Directional pattern. Omni patterns indicate that the RF patterns emanating from the antenna are omni directional most often on the horizontal plane. Omni patterns are an important category, especially for Indoor DAS or iDAS antennas but are also one of the most difficult patterns to achieve in an antenna design.

VSWR and Return Loss are two different units of measurement, but both are the measured amount of the loss of power in the signal returned/reflected by a discontinuity in a transmission line (feed structure) to the antenna. VSWR or Return Loss is a very important category in most antennas, and in DAS antennas industry standards now require a VSWR of 1.5:1 or −13.9 dB in Return Loss.

Another important category of antennas is band width. There are narrow band antennas, multi band antennas which can cover a large band width but only reach specification requirements in several narrow multi bands. There is also the SWB (super wide band antenna), which covers a large frequency band and stays within other performance specifications.

Another category of antennas is low profile. As wireless communications become more prevalent and widely used more and more antennas are populating the landscape of everyday life. Now, more than ever, Low Profile or “more aesthetically pleasing” antennas have become essential to the specification.

A noted challenge for certain antennas, such as iDAS antennas, is to meet a specification that includes Omni directional, Low VSWR or Return Loss (1.5:1 or −13.9 dB or better), SWB (iDAS 600 MHz to 6 GHz), and low profile or non-obtrusive. One or two of these specifications may be feasible to meet, however, meeting all of these specifications is counter to conventional antenna design and theory.

### SUMMARY

In some embodiments an antenna structure having a feed structure and a top radiating element attached to the feed structure, the feed structure will have a downwardly pointed, contiguous V-shaped body portion with an upper side extending between first and second inwardly extending sides. The first and second sides may meet at an apex of the V-shaped body portion.

In some embodiments the top radiating element may be attached to the feed structure along the upper side.

In some embodiments the system may further be comprised of first a tuning stub extending downwardly from the upper side. Further In some embodiments it may comprise of first and second stubs extending downwardly from opposing ends of the upper side.

In some embodiments it may further comprise of first shorting pin extending downwardly from the top radiating element and further In some embodiments it may comprise of first and second shorting pins extending downwardly from first and second portions of the top radiating element.

In some embodiments wherein the upper side of the feed structure designates the first and second portions of the top radiating element such that the first of the shorting pins is on a first side of the feed structure and the second of the shorting pins is on a second, opposing side of the feed structure.

In some embodiments it may further comprise of transmitter components operatively coupled to the antenna structure. And In some embodiments, it may further comprise of receiver components operatively coupled to the antenna structure.

In some embodiments, a further comprise is a ground plane, with the feed structure being mounted to the ground plane. And In some embodiments, it may further comprise a radome, with the top radiating element, the feed structure, and the ground plane being mounted within the radome.

In some embodiments it may further comprise a coaxial cable electrically connected to the feed structure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of a prior art antenna structure.

FIG. 2 is a graph depicting frequency coverage for a prior art antenna structure.

FIG. 3 is a schematic diagram of another prior art antenna structure.

FIG. 4 is a schematic diagram of another prior art antenna structure.

FIGS. 5-7 are schematic diagrams of an example embodiment of an antenna structure.

FIGS. 8 and 9 are schematic diagrams of an example embodiment of a feed structure.

FIGS. 10-14 are schematic diagrams of an example embodiment of an antenna structure depicting assembly detail.

FIG. 15 is a schematic diagram of an example embodiment of a system incorporating an antenna structure.

### DETAILED DESCRIPTION

Reference will now be made in detail to that which is illustrated in the drawings. While the disclosure will be described in connection with these drawings, there is no intent to limit the scope of legal protection to the embodiment or embodiments disclosed herein. Rather, the intent is to cover all alternatives, modifications and equivalents included within the spirit and scope of the disclosure as defined by the appended claims.

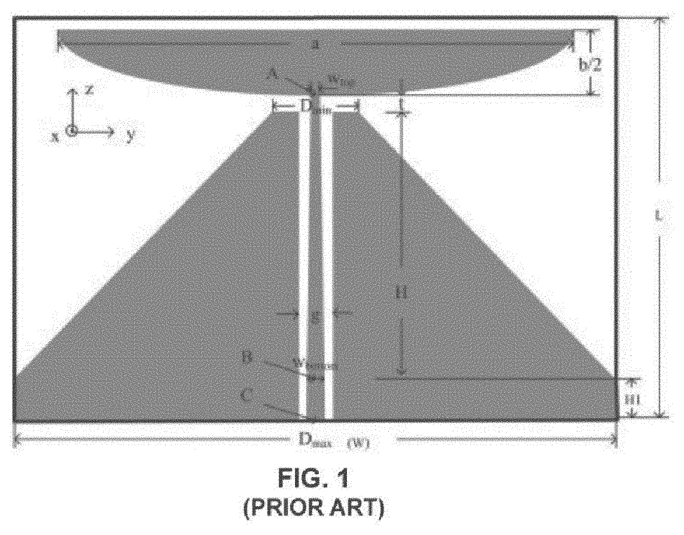

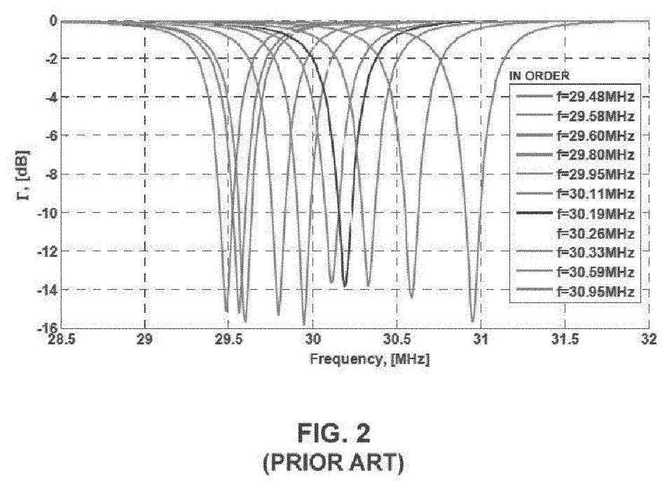

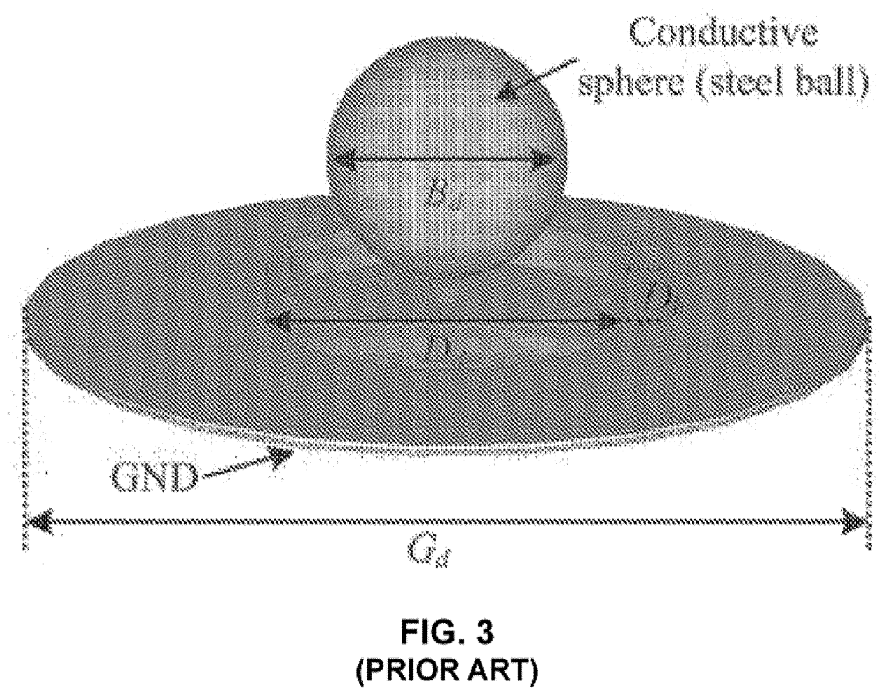

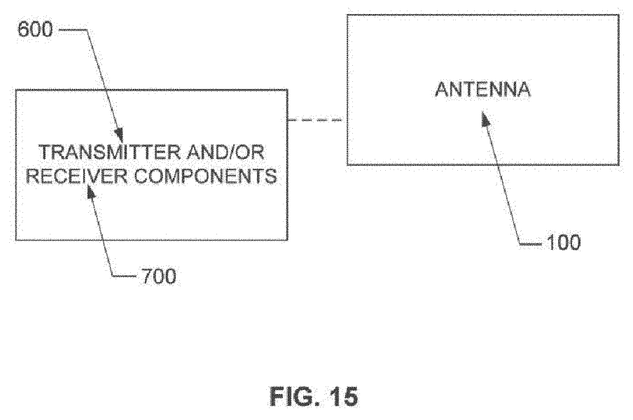

In this regard, various embodiments of the antenna provide a balance in creating a compact, super wide band antenna that provides Omni patterns and compliant VSWR. As an example, an antenna with these characteristics is uniquely capable of supporting Distributed Antenna Systems combining LTE and 5G frequencies (UWB; Ultra-Wide Band) in a single compact form. In some embodiments, such a system (FIG. 15) incorporates an antenna that combines a novel feed structure modified from the feed structure used in the Spherical or Elliptical monopole antennas. In the prior art, these feedline structures are “V” shaped and realized as tapered coplanar waveguides. These “V” shaped feed structures are either split down the middle or use meandering lines (see, FIG. 1, for example). While this structure allows for a broad coverage of frequencies, it tends to be unable to cover a contiguous broadband; rather, it is typically only capable of covering two or multiple tuned bands (see, FIG. 2, for example).

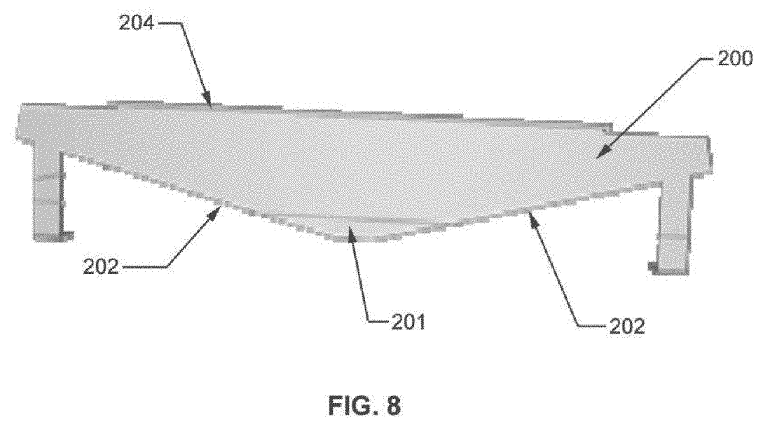

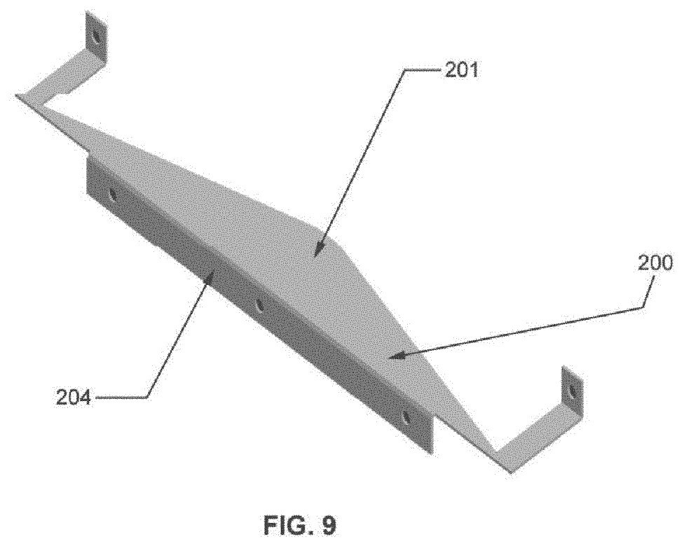

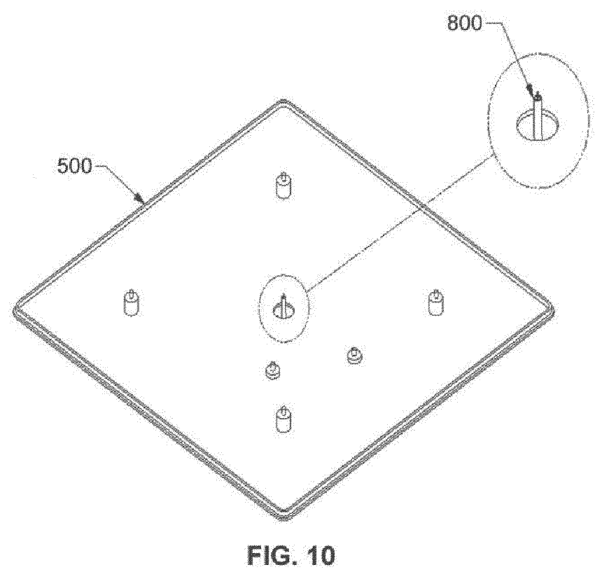

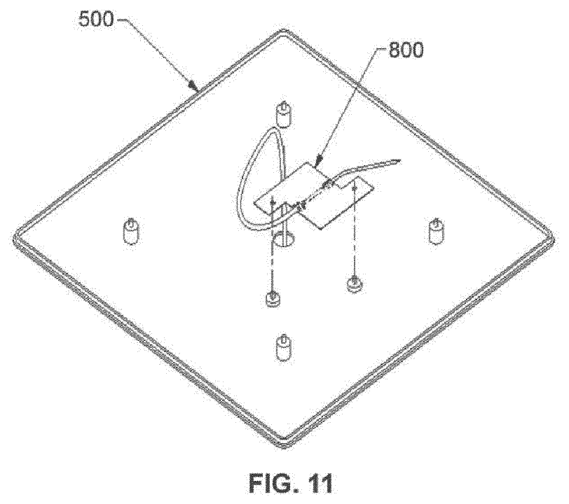

In order to overcome these perceived deficiencies, in some embodiments, the antenna feed structure is a solid “V” structure (i.e., contiguous without having a split feature). Using this novel change in design realizes the benefit of a small feed structure with the ability to cover a large (super wide frequency) in a contiguous manner. To tune this contiguous broad band of frequencies, another novel approach of this antenna incorporates the use of one or more tuning stubs that are added as “feet” to the “V” feed structure (see, FIGS. 8 and 9 for example) to interconnect the antenna feed structure to the ground plane. The shape and “thickness” of these tuning stubs determine the frequencies tuned.

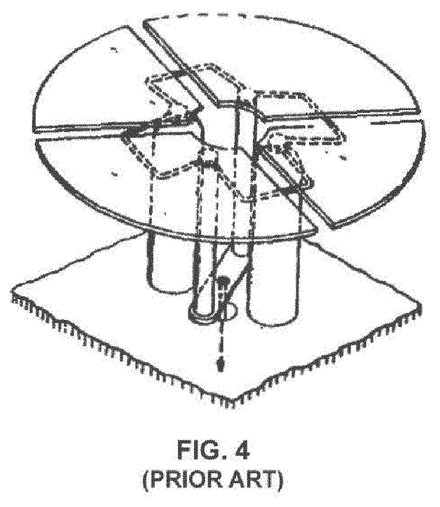

In some respects, embodiments of the antenna replace the ellipsoid on top of the feed structure with a novel designed radiating element modified from the Goubau antenna design (see, FIG. 4, for example). The Goubau antenna uses a top radiating element segmented to meet specific frequency bands that properly couple with a complex feed structure. While the Goubau antenna accommodates a broad frequency band through a complex feed structure, it is not well-suited for a contiguous super wide band frequency design.

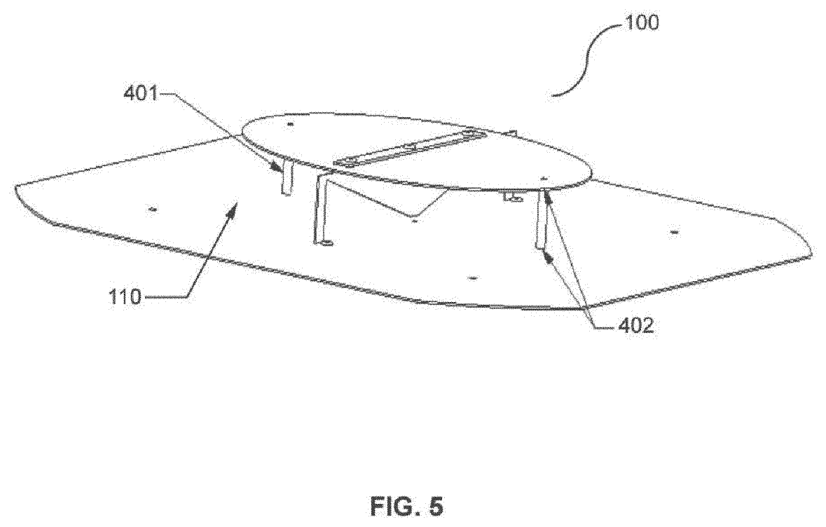

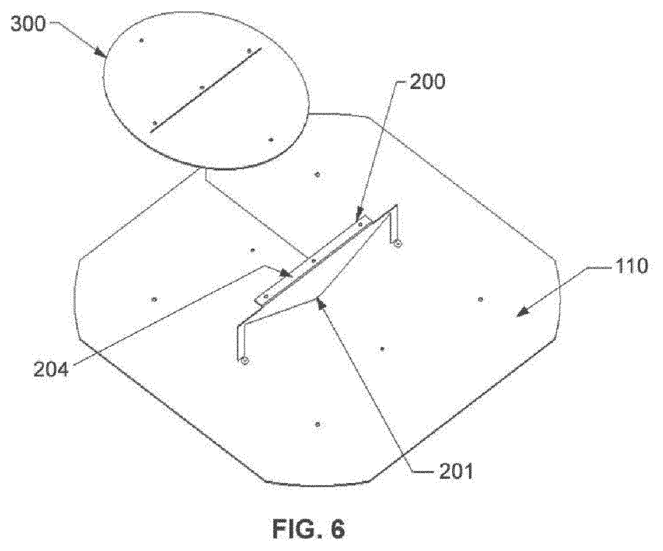

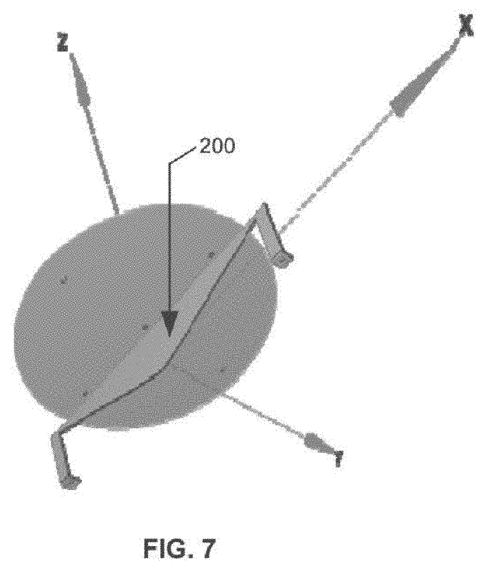

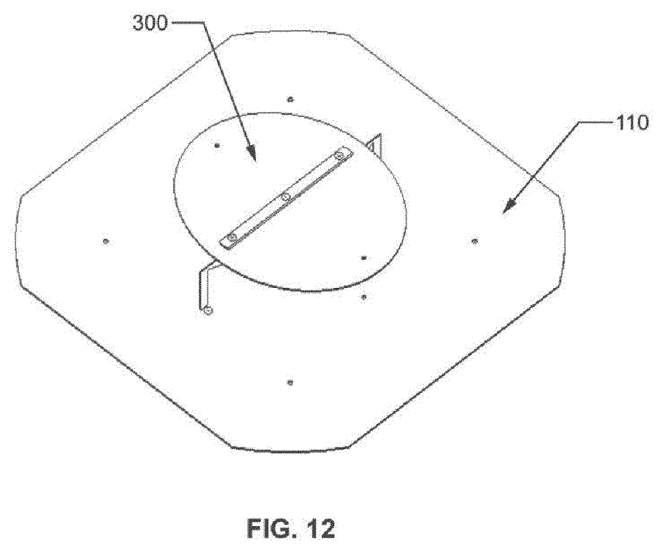

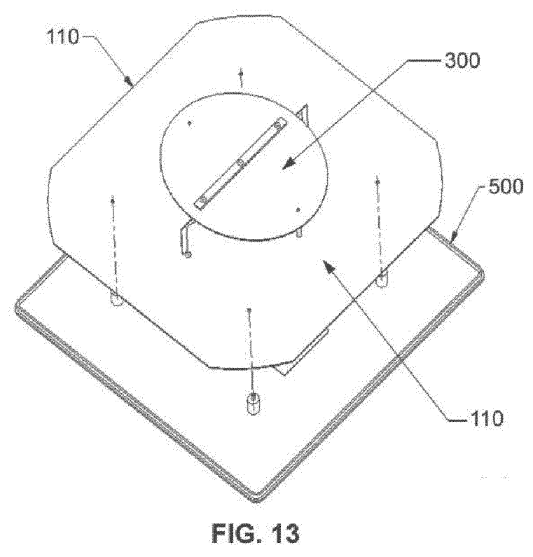

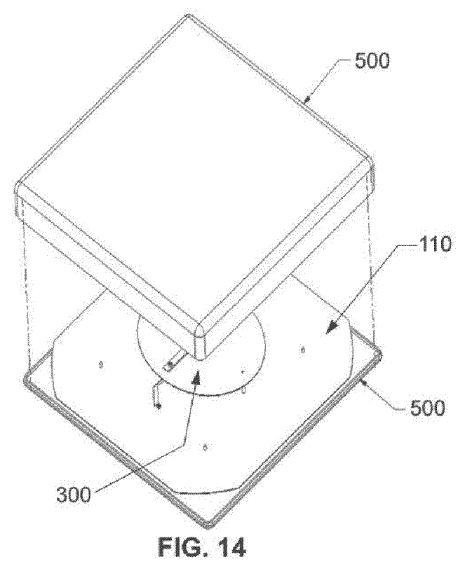

In some embodiments, the top radiating element (which is configured as a solid (contiguous) radiating element) is attached to its feed structure (see, FIGS. 5-7 and 12-14, for example). The shape of the top radiating element may be provided in various forms, such as a polygonal shape, a disk shape, etc., among others, and is generally planar. This design change coupled with our novel feed structure provides for the required contiguous Super Wide Band frequency requirements in a compact form.

In some embodiments, one or more shorting pins (FIG. 5) are interconnected between the top radiating element and the ground plane to maximize VSWR for the desired frequencies in the contiguous bandwidth provided. The shorting pin or pins are located at different locations within the area of the top radiating element. The locations are dependent on which frequency band(s) the VSWR or Return Loss is being targeted for improvement. The location of a targeted frequency band with the top metal piece and the ground plane will vary to each specific antenna design.

The solid “V” feed structure and the top radiating element allow VSWR tuning to be accomplished by the tuning stubs, which extend between the feed structure and the ground plane, rather than being restricted to the limited space using the traditional approach of using the minimally available area of the “V” feed structure (see, FIGS. 5-9, for example).

By combining modified concepts from both the Spherical and Goubau antennas, the new novel design provides embodiments of an antenna that may exhibit one or more of the following: (1) has a contiguous super wide band like those found in today's cellular network requirements that combine LTE and 5G frequency bands; (2) meets the network requirement of VSWR of 1.5:1 or better across all usable frequency bands; (3) provides Omni directional patterns necessary for coverage requirements; and, (4) comes in a compact design form factor.

In some embodiments, the antenna is Omni-directional across a SWB (Super Wide Band, e.g., 600-960, 1710-2700, 3550-3700, 5150-5900 MHz), with a VSWR of 1.5:1 or better across relevant bands and in a low-profile area. Please note that the antenna can also be scaled to other desired frequencies other than the ones listed here.

As has been described, embodiments of the antenna are designed using different unique attributes from different antennas and design types. Each of the unique features provides a performance improvement to the individual antennas, such as Return Loss, Super Wide Band Frequency range, acceptable gain patterns and low profile in form factor. But these individual antennas may or may not provide any other of the performance improvements that the other attributes provide to the other individual antennas.

Each of these unique attributes has been combined to provide all of the individual performance advantages of acceptable Return Loss, Super Wide Band Frequency range, acceptable gain patterns and are low profile in form factor. Notably, each of the design attributes may now react differently, as they interact with the other attributes in the antenna. For example, see the performance range of the Angle of “V” Feed Structure vs Gain (dB) as shown in Table 1. At a 70-degree angle of the “V” Feed Structure, the Gain is optimal across the in entire SWB. As the angle decreases, the Gain degrades, particularly in the Very High-End bands. As the angle degree increases, the Gain in the mid-range bands improves and low & high bands decrease slightly. In some embodiments, an antenna structure incorporates an Angle of “V” Feed Structure between approximately 30° and approximately 80°, preferably between approximately 70° and approximately 80°, and most preferably approximately 70°.

TABLE 1
Angle of “V” Feed Structure vs Gain (dB)

| | Flare Angle | | | | | | | | | |
|---|---|---|---|---|---|---|---|---|---|---|
| | 30 deg | | 40 deg | | 50 deg | | 70 deg | | 80 deg | |
| Freq (MHz) | Avg. RL | Worst | Avg. RL | Worst | Avg. RL | Worst | Avg. RL | Worst | Avg. RL | Worst |
| 708 | 1.94 | 0.91 | 1.94 | 0.91 | 1.97 | 1.26 | 2.01 | 1.64 | 1.97 | 1.30 |
| 924 | 2.61 | 1.57 | 2.60 | 1.57 | 2.64 | 1.74 | 2.69 | 1.90 | 2.58 | 1.35 |
| 1734 | −0.07 | −2.65 | −0.37 | −3.51 | −0.29 | −2.78 | −0.08 | −3.48 | 0.01 | −5.00 |
| 2652 | 2.41 | −0.73 | 2.59 | −0.20 | 3.57 | 1.19 | 2.99 | −2.11 | 3.37 | 1.02 |
| 3570 | 3.20 | −1.47 | 3.06 | −1.20 | 2.50 | −0.90 | 3.81 | −0.16 | 1.58 | −5.60 |
| 3678 | 3.47 | −1.18 | 3.43 | −0.19 | 3.25 | 0.98 | 4.10 | 0.74 | 1.67 | −4.38 |
| 5190 | −1.76 | −5.69 | 0.83 | −2.44 | 2.02 | −5.89 | 2.81 | −3.00 | 0.72 | −12.80 |
| 5946 | 0.80 | −5.10 | 2.49 | −6.98 | 3.26 | −2.73 | 2.68 | −2.06 | 1.70 | −17.01 |

Additionally, consider the Angle of “V” Feed Structure vs Return Loss (dB) as shown in Table 2. At a 70-degree angle of the “V” Feed Structure, the Return Loss is optimal across the in entire SWB. As the angle decreases, the Return Loss degrades quickly particularly in the Low-End bands. As the angle degree increases, the Return Loss in the low & mid-range bands improves while the High-End Bands degrade slightly.

TABLE 2
Angle of “V” Feed Structure vs Return Loss (dB)

| | Flare Angle | | | | | | | | | |
|---|---|---|---|---|---|---|---|---|---|---|
| | 30 deg | | 40 deg | | 50 deg | | 70 deg | | 80 deg | |
| Band | Avg. RL | Worst | Avg. RL | Worst | Avg. RL | Worst | Avg. RL | Worst | Avg. RL | Worst |
| 600-960 MHz | −0.10 | −0.09 | −0.25 | −0.23 | −2.09 | −1.90 | −7.12 | −6.54 | −8.20 | −7.53 |
| 1710-2700 MHz | −0.50 | −0.23 | −1.22 | −0.40 | −12.23 | −3.29 | −15.70 | −11.99 | −20.14 | −15.77 |
| 3.55 GHz-3.7 GHz | −0.62 | −0.57 | −1.30 | −1.22 | −6.48 | −6.33 | −13.17 | −12.62 | −12.03 | −11.87 |
| 5.1 GHz-6 GHz | −2.23 | −1.01 | −7.69 | −4.75 | −11.87 | −9.27 | −16.83 | −10.32 | −14.02 | −8.86 |

Additionally, consider the Area Size of Top Radiating element vs Gain (dB) as shown in Table 3. At 80.52 mm\hat{ }2 area, the Gain is optimal across the in entire SWB. As the area increases, the gain in Low-End bands begins to degrade. As the area increases, the gain in High-End bands begin to Increase and the as the area increases further a decline in High-End Gain is seen. In some embodiments, an antenna structure incorporates an Area Size of Top Radiating element between approximately 80.52 mm² and approximately 200.36 mm² preferably between approximately 80.52 mm² and approximately 139.14, and most preferably approximately 80.52 mm².

TABLE 3
Area size of Top Disk vs Gain (dB)

| | Disk Size (mm\hat{ }2) | | | | | | | | | | | |
|---|---|---|---|---|---|---|---|---|---|---|---|---|
| | 80.52 | | 96.62 | | 115.95 | | 139.14 | | 166.97 | | 200.36 | |
| Freq (MHz) | Avg. RL | Worst | Avg. RL | Worst | Avg. RL | Worst | Avg. RL | Worst | Avg. RL | Worst | Avg. RL | Worst |
| 708 | 2.01 | 1.63 | 1.99 | 1.56 | 1.92 | 1.36 | 1.77 | 0.90 | 1.44 | −0.05 | 0.88 | −1.48 |
| 924 | 2.67 | 1.78 | 2.59 | 1.57 | 2.35 | 1.06 | 1.70 | −0.05 | 0.29 | −2.90 | −0.88 | −6.24 |
| 1734 | 0.35 | −4.57 | −0.89 | −4.60 | 1.39 | 0.00 | 2.32 | −2.95 | 0.57 | −5.65 | −1.61 | −8.40 |
| 2652 | 3.52 | 1.53 | 3.22 | 0.01 | 0.97 | −2.43 | −1.10 | −15.73 | 1.66 | −4.56 | 0.43 | −3.30 |
| 3570 | 2.87 | −10.00 | 2.13 | −7.74 | 2.78 | −15.25 | 2.24 | −6.43 | 1.05 | −8.71 | 1.11 | −7.50 |
| 3678 | 3.15 | −9.64 | 2.94 | −9.09 | 2.88 | −19.59 | 2.22 | −7.03 | 0.80 | −12.55 | 1.15 | −9.01 |
| 5190 | 2.39 | −4.47 | 2.90 | −7.22 | 2.74 | −6.00 | 2.10 | −3.80 | 1.67 | −7.48 | 0.75 | −10.37 |
| 5946 | 1.91 | −10.09 | 1.67 | −17.57 | 2.48 | −6.99 | 2.32 | −13.51 | 1.18 | −12.33 | 1.44 | −4.21 |

Additionally, Area Size of Top Radiating element vs Return Loss (dB) (as shown in Table 4) may be considered as well. At 80.52 mm² area, the Return Loss is optimal across the entire SWB. As the area increases, the Low-End bands begin to degrade and the High-End Bands tend to stay constant.

TABLE 4
Area size of Top Disk vs Return Loss (dB)

| | Disk Size (mm\hat{ }2) | | | | | | | | | | | |
|---|---|---|---|---|---|---|---|---|---|---|---|---|
| | 80.52 | | 96.62 | | 115.95 | | 139.14 | | 166.97 | | 200.36 | |
| Band | Avg. RL | Worst | Avg. RL | Worst | Avg. RL | Worst | Avg. RL | Worst | Avg. RL | Worst | Avg. RL | Worst |
| 600-960 MHz | −16.62 | −14.60 | −10.44 | −9.75 | −7.53 | −6.97 | −5.39 | −4.77 | −4.06 | −3.32 | −3.14 | −2.44 |
| 1710-2700 MHz | −16.10 | −11.33 | −13.13 | −9.47 | −11.72 | −7.75 | −15.25 | −8.44 | −18.07 | −10.27 | −17.41 | −10.79 |
| 3.55 GHz-3.7 GHz | −14.10 | −13.89 | −21.71 | −19.40 | −16.44 | −16.09 | −15.95 | −15.84 | −16.22 | −14.73 | −13.93 | −13.51 |
| 5.1 GHz-6 GHz | −14.91 | −12.56 | −16.17 | −13.56 | −13.82 | −9.55 | −13.34 | −9.23 | −13.31 | −10.49 | −13.03 | −10.60 |

Now if the Height Of “V” Feed Structure vs Gain (dB) is considered as shown in Table 5, at 26.67 mm to 32.5 mm in height, the Gain is optimal across the in entire SWB. As the height increases, the High-End bands begin to degrade. So, if a higher band SWB antenna is needed, a lower “V” Feed would be used. For lower band SWB antennas, a higher “V” feed would be used. In some embodiments, an antenna structure incorporates a Height of “V” Feed Structure between approximately 15.00 mm and approximately 50 mm, preferably between approximately 15 mm and approximately 38.33 mm, and most preferably approximately 20.83 mm and approximately 32.5 mm.

TABLE 5
Height of “V” Feed Structure vs Gain (dB)

| | Height (mm) | | | | | | | | | | | | | |
|---|---|---|---|---|---|---|---|---|---|---|---|---|---|---|
| | 15.00 | | 20.83 | | 26.67 | | 32.50 | | 38.33 | | 44.17 | | 50.00 | |
| | Avg | | Avg | | Avg | | Avg | | Avg | | Avg | | Avg | |
| Freq (MHz) | Gain | Min Gain | Gain | Min Gain | Gain | Min Gain | Gain | Min Gain | Gain | Min Gain | Gain | Min Gain | Gain | Min Gain |
| 708 | 1.93 | 0.91 | 1.99 | 1.40 | 2.00 | 1.61 | 2.00 | 1.62 | 1.98 | 1.49 | 1.95 | 1.20 | 1.88 | 0.68 |
| 924 | 2.63 | 1.63 | 2.68 | 1.87 | 2.69 | 1.87 | 2.67 | 1.77 | 2.65 | 1.65 | 2.63 | 1.55 | 1.63 | −0.55 |
| 1734 | 0.03 | −2.67 | 0.06 | −2.08 | −0.38 | −3.39 | −0.37 | −4.49 | 1.07 | −2.08 | 1.75 | −1.41 | 0.59 | −3.81 |
| 2652 | 2.97 | 0.83 | 3.20 | 1.28 | 3.36 | 2.11 | 3.51 | 1.50 | 2.37 | −1.14 | 3.19 | −1.70 | 1.82 | −1.06 |
| 3570 | 0.10 | −15.19 | 3.32 | 1.16 | 3.23 | −0.24 | 2.93 | −9.74 | 2.92 | −2.86 | 1.30 | −15.71 | 0.97 | −9.14 |
| 3678 | 1.55 | −9.72 | 3.33 | 0.72 | 3.34 | −2.00 | 3.25 | −8.69 | 3.77 | −0.94 | 1.47 | −14.59 | 0.80 | −16.51 |
| 5190 | 4.42 | 1.88 | 4.42 | 0.27 | 3.93 | −12.64 | 2.31 | −4.53 | 0.75 | −10.43 | −0.49 | −14.56 | 0.79 | −6.38 |
| 5946 | 3.32 | −4.26 | 4.27 | −0.63 | 3.94 | −7.06 | 2.24 | −6.51 | −0.13 | −5.42 | 0.70 | −9.92 | 0.48 | −22.06 |

With regards to Height Of “V” Feed Structure vs Return Loss (dB) as shown in Table 6, at 26.67 mm to 32.5 mm in height, the Return loss is optimal across the entire SWB. As the height increases, the High-End bands begin to degrade. As the height decreases, the Low-End bands begin to decrease. Thus, if a higher band SWB antenna is needed, a lower “V” Feed would be used. For lower band SWB antennas, a higher “V” feed would be used.

TABLE 6
Height of “V” Feed Structure vs Return Loss (dB)

| | Height (mm) | | | | | | | |
|---|---|---|---|---|---|---|---|---|
| | 15.00 | | 20.83 | | 26.67 | | 32.50 | |
| Band | Avg. RL | Worst | Avg. RL | Worst | Avg. RL | Worst | Avg. RL | Worst |
| 600-960 MHz | −4.73 | −1.58 | −8.26 | −4.16 | −15.08 | −14.47 | −16.25 | −14.32 |
| 1710-2700 MHz | −5.57 | −3.2 | −10.63 | −7.2 | −15.86 | −10.2 | −16.04 | −10.85 |
| 3.55 GHz-3.7 GHz | −8.37 | −7.83 | −14.33 | −13.78 | −16.42 | −15.87 | −13.02 | −12.77 |
| 5.1 GHz-6 GHz | −21.54 | −14.29 | −24.2 | −15.25 | −15 | −12.15 | −16.06 | −13.88 |

| | Height (mm) | | | | | |
|---|---|---|---|---|---|---|
| | 38.33 | | 44.17 | | 50.00 | |
| Band | Avg. RL | Worst | Avg. RL | Worst | Avg. RL | Worst |
| 600-960 MHz | −15.33 | −13.87 | −15.22 | −13.04 | −13.47 | −11.5 |
| 1710-2700 MHz | −15.38 | −9.2 | −17.87 | −13.89 | −23.89 | −15.98 |
| 3.55 GHz-3.7 GHz | −10.9 | −10.47 | −11.76 | −11.33 | −15.93 | −13.48 |
| 5.1 GHz-6 GHz | −11.78 | −9.32 | −17.17 | −11.6 | −14.79 | −9.6 |

As described earlier, an embodiment of an antenna structure may be incorporated into a system, such as that depicted in FIG. 15. Such a system may include various components, such as transmitter and/or receiver components operatively coupled to the antenna structure. Various other components for facilitating operation may include a processing device (processor), input/output interfaces, a display, a touchscreen interface, a network interface, and a memory, with each communicating across a local data bus in some embodiments.

Processing device may include any custom made or commercially available processor, a central processing unit (CPU) or an auxiliary processor among several processors, a semiconductor based microprocessor (in the form of a microchip), one or more application specific integrated circuits (ASICs), a plurality of suitably configured digital logic gates, and other electrical configurations comprising discrete elements both individually and in various combinations to coordinate the overall operation of the system.

Memory can include any of a combination of volatile memory elements (e.g., random-access memory (RAM, such as DRAM, and SRAM, etc.)) and nonvolatile memory elements. Memory typically comprises native operating system, one or more native applications, emulation systems, or emulated applications for any of a variety of operating systems and/or emulated hardware platforms, emulated operating systems, etc. For example, the applications may include application specific software which may comprise some or all the components of the system. In accordance with such embodiments, the components are stored in memory and executed by the processing device.

One of ordinary skill in the art will appreciate that memory can, and typically will, comprise other components which have been omitted for purposes of brevity. Note that in the context of this disclosure, a non-transitory computer-readable medium stores one or more programs for use by or in connection with an instruction execution system, apparatus, or device.

Network interface comprises various components used to transmit and/or receive data. When such components are embodied as an application, the one or more components may be stored on a non-transitory computer-readable medium and executed by the processing device.

It should be emphasized that the above-described embodiments are merely examples of possible implementations. Many variations and modifications may be made to the above-described embodiments without departing from the principles of the present disclosure. By way of example, the antenna can be realized in multiple configurations, such as a SISO, MIMO, single element antenna, or multi-element array antenna, for example. All such modifications and variations are intended to be included herein within the scope of this disclosure and protected by the following claims.

### DETAILED DESCRIPTION

In some embodiments an antenna structure [100] having a feed structure [200] and a top radiating element [300] attached to the feed structure [200], the feed structure will have a downwardly pointed, contiguous V-shaped [201] body portion with an upper side extending between first and second inwardly [202] extending sides. The first and second sides may meet at an apex [201] of the V-shaped body portion.

In some embodiments the top radiating element [300] may be attached to the feed structure along the upper side [204].

In some embodiments the system may further be comprised of first a tuning stub [401] extending downwardly from the upper side. Further In some embodiments it may comprise of first [401] and second stubs [402] extending downwardly from opposing ends of the upper side.

In some embodiments it may further comprise of first shorting pin [401] extending downwardly from the top radiating [300] element and further In some embodiments it may comprise of first and second shorting pins [402] extending downwardly from first and second portions of the top radiating element [300].

In some embodiments wherein the upper side of the feed structure [204] designates the first and second portions of the top radiating element [300] such that the first of the shorting pins [401] is on a first side of the feed structure and the second of the shorting pins [402] is on a second, opposing side of the feed structure [200].

In some embodiments it may further comprise of a transmitter components [600] operatively coupled to the antenna structure [100]. And In some embodiments it may further comprise of receiver components [700] operatively coupled to the antenna structure [100].

In some embodiments it further comprise of a ground plane [110], with the feed structure [200] being mounted to the ground plane [110]. And In some embodiments it may further comprise of a radome [500], with the top radiating element [300], the feed structure [200], and the ground plane [110] being mounted within the radome [500].

In some embodiments it may further comprise of a coaxial cable [800] electrically connected to the feed structure [200].

### COMPONENT LIST

antenna structure [100]
ground plane [110]
feed structure [200]
feed structure V-shape apex [201]
feed structure first and second inwardly extending sides [202]
feed structure upper side [204]
top radiating element [300]
first tuning stub [401]
second tuning stubs [402]
radome [500]
transmitter [600]
receiver [700]
coaxial cable [800]

What is claimed is:

1. A system comprising:
an antenna structure having a feed structure and a top radiating element attached to the feed structure;
the feed structure having a downwardly pointed, contiguous V-shaped body portion with an upper side extending between first and second inwardly extending sides, the first and second sides meeting at an apex of the V-shaped body portion;
the top radiating element being attached to the feed structure along the upper side.

2. The system of claim 1, further comprising a first tuning stub extending downwardly from the upper side.

3. The system of claim 1, further comprising first and second stubs extending downwardly from opposing ends of the upper side.

4. The system of claim 1, further comprising a first shorting pin extending downwardly from the top radiating element.

5. The system of claim 1, further comprising first and second shorting pins extending downwardly from first and second portions of the top radiating element.

6. The system of claim 5, wherein the upper side of the feed structure designates the first and second portions of the top radiating element such that the first of the shorting pins is on a first side of the feed structure and the second of the shorting pins is on a second, opposing side of the feed structure.

7. The system of claim 1, further comprising transmitter components operatively coupled to the antenna structure.

8. The system of claim 1, further comprising receiver components operatively coupled to the antenna structure.

9. The system of claim 1, further comprising a ground plane, with thefeed structure being mounted to the ground plane.

10. The system of claim 1, further comprising a radome, with the top radiating element, the feed structure, and the ground plane being mounted within the radome.

11. The system of claim 1, further comprising a coaxial cable electrically connected to the feed structure.
